(19) United States
(12) Patent Application Publication
(10) Pub. No.: US 2025/0197256 A1
(43) Pub. Date: Jun. 19, 2025

(54) SYSTEMS AND METHODS FOR DESTROYING PER- AND POLYFLUOROALKYL SUBSTANCES (PFAS) USING AN ELECTROCHEMICAL (EC) REACTOR

(71) Applicant: AECOM, Dallas, TX (US)

(72) Inventors: Rachael A. Casson, Sydney (AU); Lucy Benkeser Pugh, Alto, MI (US); Keith Russell Maxfield, Melbourne (AU); Shangtao Liang, Richmond, CA (US); Brock Aaron Hodgson, Murray, UT (US); Nazar Al-khayat, Phoenix, AZ (US); Gavin Peter Scherer, Melbourne (AU); Rosa E. Gwinn, Silver Spring, MD (US); Rebecca Hamilton Mora, Severna Park, MD (US)

(21) Appl. No.: 18/845,666

(22) PCT Filed: Mar. 9, 2023
(86) PCT No.: PCT/US2023/064068

§ 371 Date: Sep. 10, 2024

Related U.S. Application Data
(60) Provisional application No. 63/269,241, filed on Mar. 11, 2022.

(51) Int. Cl. C02F 1/467; C02F 1/00; C02F 1/461; C02F 1/68; C02F 101/36; C02F 103/06

(52) U.S. Cl. CPC C02F 1/4672; C02F 1/004; C02F 1/46109; C02F 1/68; C02F 2001/46133; C02F 2001/46171; C02F 2101/36; C02F 2103/06; C02F 2209/02; C02F 2209/05; C02F 2209/06; C02F 2301/04; C02F 2303/12

(57) ABSTRACT

A treatment system including an influent pump to pump influent fluid stream containing PFAS into the system. The system may include a flow recirculation system including a fluid circuit through which a recirculating fluid stream flows, an electrochemical (EC) reactor comprising at least one pair of electrodes. When the EC reactor is in a first operational mode, a current generated between the anode electrode and the cathode electrode destroys at least some of the PFAS. The system may include a foam management system to reduce an amount of foam in a container of the EC reactor. The system may include a chemical management system to inject a chemical into the recirculating fluid stream. The system may include a temperature control system to regulate a temperature of the recirculating fluid stream. The system may include a recirculation pump to pump the recirculating fluid stream through the flow recirculation system.

### INCORPORATION BY REFERENCE TO ANY PRIORITY APPLICATIONS

This application claims priority to U.S. Provisional Patent Application No. 63/269,241, filed Mar. 11, 2022, which is hereby incorporated by reference in its entirety.

### BACKGROUND

Per- and polyfluoroalkyl substances (PFAS) are organic compounds that include fluorine, carbon and heteroatoms such as oxygen, nitrogen and sulfur. The hydrophobicity of fluorocarbons and extreme electronegativity of fluorine give these and similar compounds unusual properties. Initially many of these compounds were used as gases in fabrication of integrated circuits. The ozone destroying properties of these molecules restricted their use and resulted in methods to prevent their release into the atmosphere. But other PFAS such as fluoro-surfactants have become increasingly popular. Although used in relatively small amounts, these compounds are readily released into the environment where their extreme hydrophobicity as well as negligible rates of natural decomposition results in environmental persistence and bioaccumulation. It appears as if even low levels of bioaccumulation may lead to serious health consequences for contaminated animals such as human beings, the young being especially susceptible. The environmental effects of these compounds on plants and microbes are as yet largely unknown. Nevertheless, it can be important to limit the environmental release of PFAS.

### BRIEF SUMMARY

In one aspect, a treatment system is provided for destroying at least one of a perfluoroalkyl and polyfluoroalkyl substance (PFAS) contained in an influent fluid stream. The system includes an influent pump, configured to pump the influent fluid stream into the treatment system; and a flow recirculation system including a fluid circuit through which a recirculating fluid stream flows. The flow recirculation system includes an electrochemical (EC) reactor with at least one pair of electrodes, including an anode electrode and a cathode electrode, and can switch between a first operational mode for destroying at least some of the PFAS as it the recirculating fluid stream flows through the EC reactor, and a second operational mode. The flow recirculation system also includes a foam management system with at least one overhead nozzle positioned vertically over a center region of the EC reactor and configured to dispense a portion of the recirculating fluid stream vertically downward toward the EC reactor to reduce an amount of foam in a container of the EC reactor. The flow recirculation system also includes a chemical management system, including at least one chemical injector response to at least one sensor in communication with the injector. The flow recirculation system also includes a temperature control system including a chiller. The temperature control system can regulate a temperature of the recirculating fluid stream. The flow recirculation system also includes a recirculation pump configured to pump the recirculating fluid stream through the flow recirculation system. The treatment system also includes an effluent pump configured to pump an effluent fluid stream including a portion of the recirculating fluid stream out of the flow recirculation system along an effluent line. The treatment system can include a second EC reactor connected to and positioned downstream of the EC reactor and configured to receive at least a portion of a fluid stream output from the EC reactor.

In another aspect, a treatment system is provided for destroying at least one of a perfluoroalkyl and polyfluoroalkyl substance (PFAS) contained in an influent fluid stream. The system includes an influent line configured to supply the influent fluid stream to the treatment system, a flow recirculation system, and an effluent line. The flow recirculation system includes a fluid circuit through which a recirculating fluid stream flows, and an electrochemical reactor (EC) configured to destroy at least some of the PFAS in the recirculating fluid stream as the recirculating fluid stream flows through the EC reactor. The effluent line is configured to remove an effluent fluid stream that includes a portion of the recirculating fluid stream from the flow recirculation system along the effluent line.

In another aspect, a treatment system is provided for destroying at least one of a perfluoroalkyl and polyfluoroalkyl substance (PFAS) contained in an influent fluid stream. The system includes an electrochemical (EC) reactor configured to operate in a plurality of operational modes. The EC reactor includes at least one pair of electrodes including an anode electrode and a cathode electrode configured to destroy at least some of the PFAS in a recirculating fluid stream as the recirculating fluid stream flows through the EC reactor. The EC reactor also includes a controller configured to automatically toggle between the plurality of operational modes of the EC reactor.

In another aspect, a treatment system is provided for destroying at least one of a perfluoroalkyl and polyfluoroalkyl substance (PFAS) contained in an influent fluid stream. The system includes a flow recirculation system including a fluid circuit through which a recirculating fluid stream flows. The flow recirculation system includes an electrochemical (EC) reactor configured to destroy at least some of the PFAS in the recirculating fluid stream as the recirculating fluid stream flows through the EC reactor. A chemical management system is in fluid connection with the flow recirculation system and includes at least one sensor and at least one injector. The at least one injector is configured to inject a chemical into the flow recirculation system at least in part upon receiving an instruction from the at least one sensor. The at least one sensor is configured to detect at least one fluid property of the recirculating fluid stream.

In another aspect, a treatment system is provided for destroying at least one of a perfluoroalkyl and polyfluoroalkyl substance (PFAS) contained in an influent fluid stream. The system includes a flow recirculation system including a fluid circuit through which a recirculating fluid stream flows. The flow recirculation system includes an electrochemical (EC) reactor configured to destroy at least some of the PFAS in the recirculating fluid stream as the recirculating fluid stream flows through the EC reactor; and a temperature control system includes a chiller. The temperature control system is configured to regulate a temperature of the recirculating fluid stream.

In another aspect, a treatment system is provided for destroying at least one of a perfluoroalkyl and polyfluoroalkyl substance (PFAS) contained in an influent fluid stream. The system includes an electrochemical (EC) reactor configured to destroy at least some of the PFAS in the recirculating fluid stream as the recirculating fluid stream flows through the EC reactor; and a foam management system including at least one overhead nozzle positioned vertically over a central region of the EC reactor. The nozzle is configured to dispense a portion of the recirculating fluid stream vertically downward over the EC reactor to reduce an amount of foam generated by the EC reactor.

In another aspect, a treatment system is provided for destroying at least one of a perfluoroalkyl and polyfluoroalkyl substance (PFAS) contained in an influent fluid stream, The system includes a flow recirculation system including a fluid circuit through which a recirculating fluid stream flows. The flow recirculation system includes an electrochemical (EC) reactor configured to destroy at least some of the PFAS in the recirculating fluid stream as the recirculating fluid stream flows through the EC reactor. The system also includes an exhaust management system in fluid communication with the flow recirculation system and including a circuit through which an exhaust gas stream flows.

In another aspect, a treatment system is provided for destroying at least one of a perfluoroalkyl and polyfluoroalkyl substance (PFAS) contained in an influent fluid stream. The system includes a flow recirculation system including a fluid circuit through which a recirculating fluid stream flows. The flow recirculation system includes an electrochemical (EC) reactor having an array of vertically extending electrode pairs and configured to destroy at least some of the PFAS in the recirculating fluid stream as the recirculating fluid stream continuously flows through the EC reactor. The EC reactor is disposed in a container configured to be transported from a first location to a second location.

In another aspect, a method is provided for destroying at least one of a perfluoroalkyl and polyfluoroalkyl substance (PFAS) contained in an influent fluid stream. The method includes flowing the influent fluid stream into a treatment system at an average influent rate; flowing a recirculating fluid stream through a recirculation system having an electrochemical (EC) reactor configured to destroy at least some of the PFAS in the recirculating fluid stream as the recirculating fluid stream flows through the EC reactor at an average recirculation rate; and removing an effluent fluid stream including a portion of the recirculating fluid stream from the recirculation system at an average effluent rate.

In another aspect, a method is provided for destroying at least one of a perfluoroalkyl and polyfluoroalkyl substance (PFAS) contained in an influent fluid stream. The method includes flowing the influent fluid stream into a treatment system; flowing a recirculating fluid stream through a recirculation system having an electrochemical (EC) reactor; operating the EC reactor in a first operational mode to destroy at least some of the PFAS in the recirculating fluid stream as the recirculating fluid stream flows through the EC reactor; automatically switching the EC reactor to a second operational mode using a controller to treat a byproduct generated by the EC reactor; and removing an effluent fluid stream including a portion of the recirculating fluid stream from the recirculation system.

In another aspect, a method is provided for destroying at least one of a perfluoroalkyl and polyfluoroalkyl substance (PFAS) contained in an influent fluid stream. The method includes flowing the influent fluid stream into a treatment system at an average influent rate; destroying at least some of the PFAS in a recirculation fluid stream by flowing the recirculating fluid stream through a recirculation system having an electrochemical (EC) reactor; removing an effluent fluid stream including a portion of the recirculating fluid stream from the recirculation system at an average effluent rate; and regulating a temperature of the recirculating fluid stream with a temperature control system having a chiller.

In another aspect, a method is provided for destroying at least one of a perfluoroalkyl and polyfluoroalkyl substance (PFAS) contained in an influent fluid stream. The method includes flowing the influent fluid stream into a treatment system at an average influent rate; flowing a recirculating fluid stream through a recirculation system having an electrochemical (EC) reactor; operating the EC reactor to destroy at least some of the PFAS in the recirculating fluid stream removing an effluent fluid stream including a portion of the recirculating fluid stream from the recirculation system at an average effluent rate; and automatically regulating at least one fluid property of the recirculating fluid stream.

In another aspect, a method is provided for destroying at least one of a perfluoroalkyl and polyfluoroalkyl substance (PFAS) contained in an influent fluid stream. The method includes flowing the influent fluid stream into a treatment system at an average influent rate; flowing a recirculating fluid stream through a recirculation system having an electrochemical (EC) reactor; operating the EC reactor to destroy at least some of the PFAS in the recirculating fluid stream; removing an effluent fluid stream including a portion of the recirculating fluid stream from the recirculation system at an average effluent rate; and reducing an amount of foam generated by the EC reactor by dispensing a portion of the recirculating fluid stream directly downward over a central region of the EC reactor using an overhead nozzle positioned vertically over the central region of the EC reactor.

### BRIEF DESCRIPTION OF THE DRAWINGS

FIG. 1A shows a schematic illustration of one embodiment of a treatment system for destroying at least some PFAS contained in a fluid stream.

FIG. 1B shows a schematic illustration of one embodiment of a filtration system.

FIG. 1C shows a schematic illustration of one embodiment of a chemical management system.

FIG. 1D shows a schematic illustration of one embodiment of a temperature control system.

FIG. 1E shows a schematic view of one embodiment of an electrochemical (EC) reactor container and a foam management system.

FIG. 1F shows the flow of the recirculating fluid stream through an electrode tube.

FIG. 2 shows a schematic illustration of one embodiment of a treatment system for destroying at least some PFAS contained in a fluid stream.

FIGS. 3A-D show various views of an embodiment of an electrochemical (EC) reactor container.

FIG. 3E shows a cross section view of an embodiment of an electrode tube.

FIG. 4A shows a schematic view of an embodiment of an exhaust management system having a scrubber and a granular activated carbon (GAC) system.

FIG. 4B shows a schematic view of an embodiment of a scrubber of the exhaust system.

FIG. 4C shows a schematic view of an embodiment of a GAC system of the exhaust system.

### DETAILED DESCRIPTION

Treatment systems for destroying per- and polyfluoroalkyl substances (PFAS) contained in a fluid stream can include an electrochemical (EC) reactor configured to destroy at least some of the PFAS contained in the fluid stream as the fluid stream flows through the EC reactor. It can be important to ensure that the EC reactor of the treatment system runs efficiently to maximize the amount of PFAS destroyed by the treatment system. For example, the chemical properties, recirculation rate, and temperature of the fluid stream, among other factors, can impact the efficiency of the treatment system. Accordingly, there remains a continuing need for improved treatment systems for destroying PFAS.

The disclosed embodiments relate to a treatment system for destroying at least one of a perfluoro and polyfluoroalkyl substance (PFAS) contained in an influent fluid stream using an electrochemical (EC) reactor, and methods of destroying PFAS in a fluid stream using a treatment system having an EC reactor.

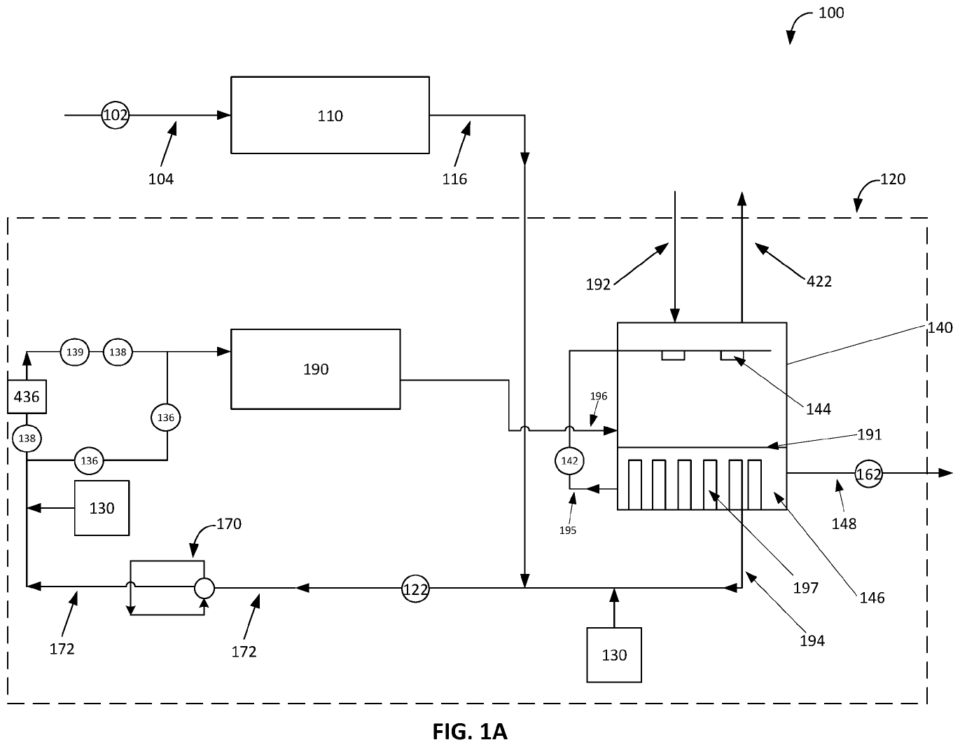

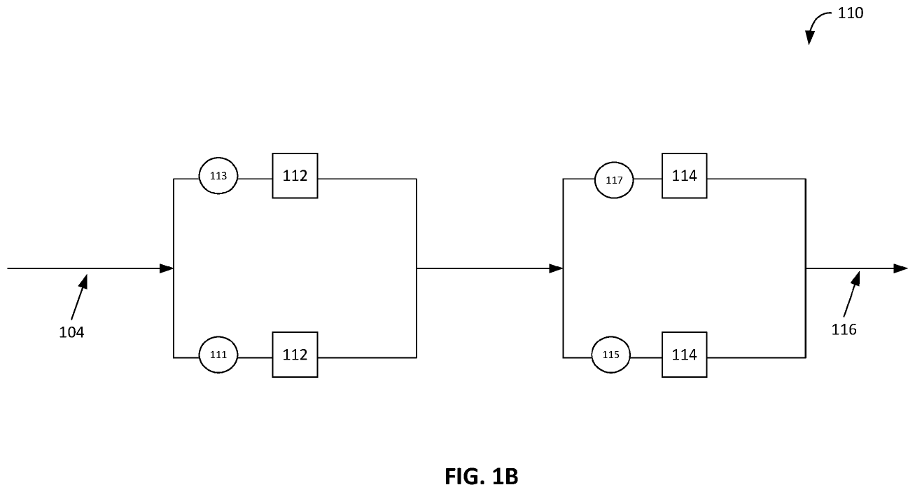

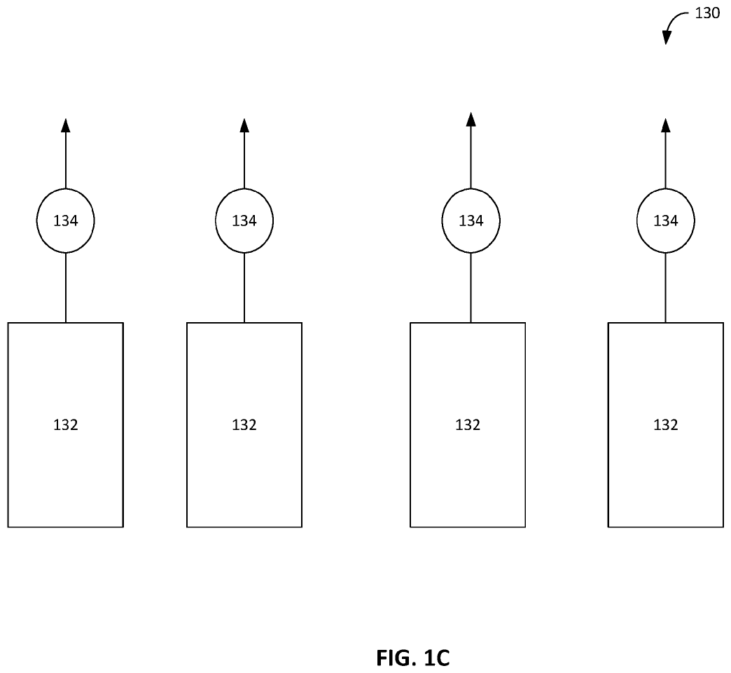

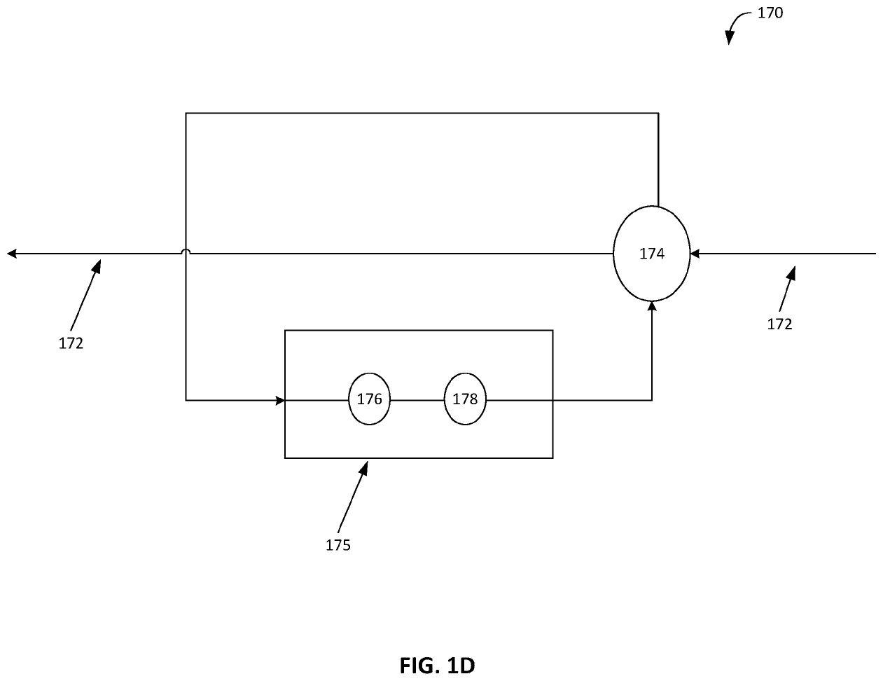

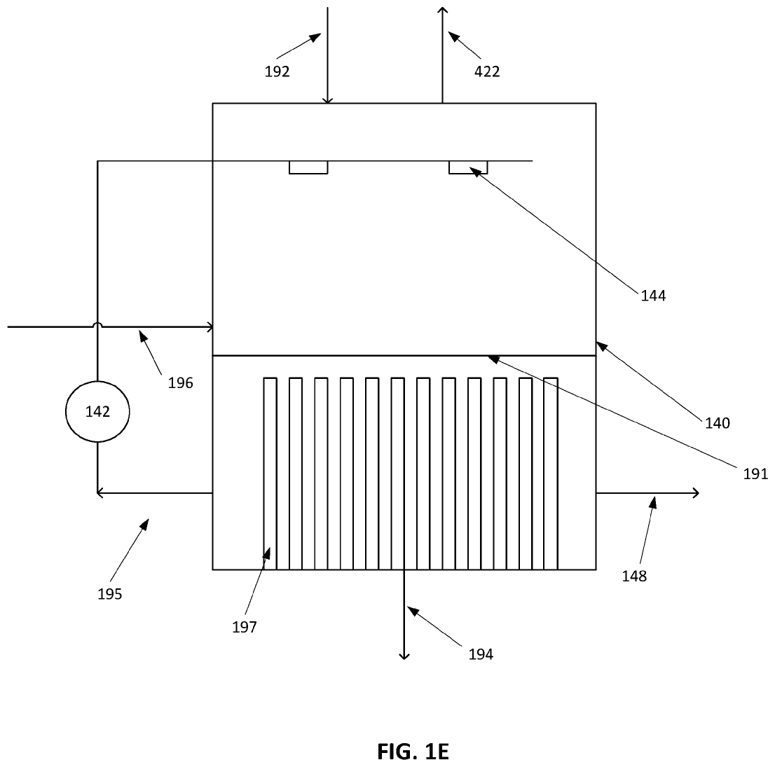

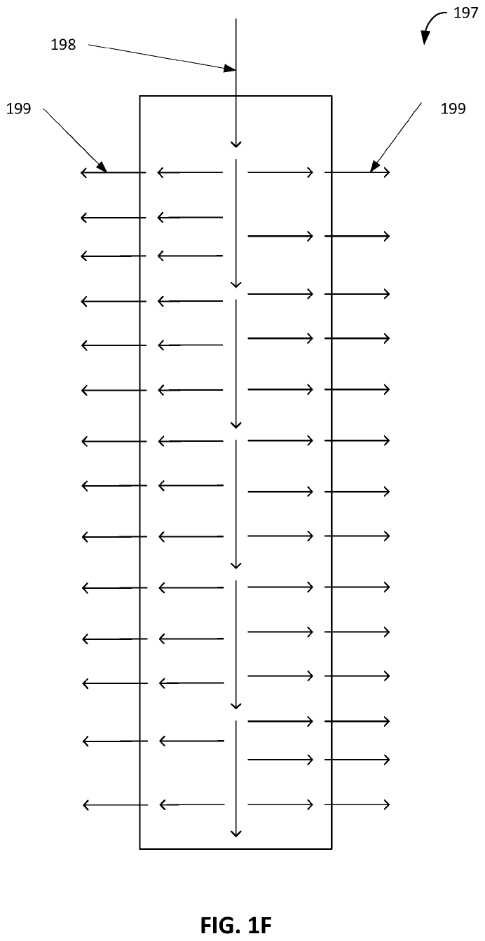

FIG. 1A shows a schematic illustration of one embodiment of a treatment system 100 for destroying PFAS contained in a fluid stream. The treatment system 100 can be configured to operate in continuous flow mode. In other embodiments, the treatment system 100 can operate in a batch mode or pseudo-batch mode. In a batch mode or pseudo-batch mode, the conveyance of influent fluid stream into the treatment system can be paused intermittently to allow treatment to occur in a pulsed manner within the electrochemical reactor, thus ensuring that all the influent fluid stream experiences a period of continuous treatment within the electrochemical reactor. The treatment system 100 can include one or more filtration systems 110, 190, a temperature control system 170, a chemical management system 130, a foam management system, an exhaust management system, and an electrochemical (EC) reactor.

In one embodiment of the system, an influent fluid stream containing PFAS can be conveyed into the treatment system 100 via an influent line segment 104. A pump 102 can facilitate delivery of the influent liquid stream into the treatment system 100 by pumping the influent liquid stream into the treatment system 100. The influent liquid stream can include various liquids, including liquid chemical wastes, wastewater, surface water, drinking water, groundwater, commercial or industrial chemical byproducts or waste streams, or a mixture thereof. Upon infusion of the influent liquid stream into the treatment system 100 via the influent line segment 104, the influent liquid stream can flow through a filtration system 110 that can be configured to filter solid material from the influent fluid stream. Beneficially, filtering solid material from the influent fluid stream can improve the efficiency of the treatment system 100 by reducing the risk of clogging along the various line segments and components of the treatment system 100 including the EC reactor. The filtration system 110 can include one or more filters, and one or more valves that can be configured to distribute the flow of the influent fluid stream through the filtration system 110. Beneficially, this can allow servicing of the filtration system 110 (e.g., replacing a filter) without interrupting the flow of the influent liquid stream along the filtration system 110.

The influent fluid stream can exit the filtration system 110 via a line segment 116. After exiting the filtration system 110 via the line segment 116, the influent fluid stream can be directed into a flow recirculation system 120 to form a recirculating fluid stream. The flow recirculation system 120 can include a fluid circuit through which the recirculating fluid stream can flow. The recirculating fluid stream can flow through a temperature control system 170 via a line segment 172 of the fluid circuit. The temperature control system 170 can beneficially allow for fluid cooling using a chiller and/or heat-exchanger to manage heat accumulation within the fluid being treated in the treatment system 100. To minimize volatilization of the recirculating fluid stream containing PFAS and improve the efficiency of the treatment system 100, the temperature control system 170 can be configured to maintain a temperature of the recirculating fluids stream below a threshold temperature. The threshold temperature can be, for example, 30° C., 35° C., 40° C., 45° C., 50° C., or 55° C. The threshold temperature may be static or dynamic. Minimizing volatilization can prevent the PFAS from escaping the treatment system 100 into the atmosphere via the exhaust management system of the treatment system 100. The temperature control system includes a heat exchanger that can be configured to control a temperature of the recirculating fluid stream. Beneficially, controlling the temperature of the recirculating fluid stream as the recirculating fluid stream flows through the heat exchanger can indirectly control the temperature of the EC reactor by way of the fluid that enters the EC reactor. For example, heat can be generated in the EC reactor through oxidation/reduction reactions, and controlling the temperature of the recirculating fluid can help keep the EC reactor in a desirable temperature range. The line segment 172 through which the recircling fluid stream flows can be configured to pass through the heat exchanger of the temperature control system 170 thereby regulating the temperature of the recirculating fluid stream.

The flow recirculation system 120 can also include a chemical management system 130. The chemical management system 130 can be in fluid connection with the flow circuit of the flow recirculation system 120 and can be configured to automatically regulate the chemical properties (e.g., water conditioning) of the recirculating fluid stream. The chemical properties of the recirculating fluid stream can include one or more of a chemical concentration, a temperature, an electrical conductivity, a pH level, and an oxidation reduction potential (ORP). The chemical management system 130 can include at least one sensor 139 and at least one injector. The injector can be configured to automatically inject one or multiple chemicals into the recirculating fluid stream. A static mixer 436 can be positioned along the fluid circuit of the flow recirculation system 120 and downstream of the chemical management system 130. In some embodiments, the static mixer 436 can include a 2-40C-4-6-2 static mixer, commercially available from KOFLO of Cary, Illinois, United States, and/or similar static mixers. The static mixer 436 can be configured to mix the chemical(s) injected by the injector of the chemical management system and the recirculating fluid stream. Although desirably illustrated along the flow recirculation system 120, the at least one sensor 139 and the at least one injector of the chemical management system 130 can be positioned anywhere in the system where their feedback can be used in closed loop or open loop to regulate the chemical properties of the recirculating fluid stream.

In some embodiments, the at least one sensor 139 of the chemical management system 130 includes a pH sensor configured to detect a pH level of the recirculating fluid stream. In some embodiments, the pH sensor can include an Memosens CPS16D sensor, commercially available from Endress+Hauser of Reinach, Switzerland, and/or similar pH sensors. The pH sensor can include a pH transmitter (PHT) sensor configured to measure, at least one of a pH level, temperature, and oxidation reduction potential (ORP). Maintaining the pH level of the recirculating fluid stream at or within a range of a pH threshold value can improve the efficiency of the treatment system 100. The pH threshold value can be, for example, any value from 1 to 14. In some embodiments, the pH threshold value is in a target value within a range from 5 to 7. In other embodiments, two pH threshold values are provided to keep the pH within a desired range, such as for example, from 5 to 7. To maintain the pH level of the recirculating fluid stream at or within a range of the pH threshold value, the pH sensor can be configured to be in communication with the at least one injector of the chemical management system 130 and instruct the at least one injector to inject an alkaline substance, to increase the pH level of the recirculating fluid stream, or an acidic substance, to decrease the pH level of the recirculating fluid stream, thereby regulating the pH level of the recirculating fluid stream. The pH sensor can instruct the at least one injector of the chemical management system 130 to inject at least one of an alkaline substance and an acidic substance at least in part upon measuring a pH level outside the pH threshold level. The pH sensor can also be configured to monitor the resulting pH level and instruct the at least one injector to stop injecting at least one of an alkaline substance and an acidic substance once the pH level reaches the desired value. The pH sensor can instruct the at least one injector of the chemical management system 130 to stop injecting at least one of an alkaline substance and an acidic substance at least in part upon measuring a pH level at or within a range of desired pH levels. In other embodiments, the pH sensor can communicate with a controller. In some embodiments, the controller can include a Model TM251MESE controller, commercially available from Schneider Electric of Rueil-Malmaison, France, and/or similar controllers. The controller can be configured to instruct the at least one injector of the chemical management system 130 to inject an alkaline substance, to increase the pH level of the recirculating fluid stream, or an acidic substance, to decrease the pH level of the recirculating fluid stream, thereby regulating the pH level of the recirculating fluid stream, at least in part upon receiving readings from the pH sensor. The pH sensor can communicate with the controller which in turn can instruct the at least one injector of the chemical management system 130 to inject at least one of an alkaline substance and an acidic substance at least in part upon measuring a pH level outside the pH threshold level. The pH sensor can also be configured to monitor the resulting pH level and communicate with the controller which in turn can instruct the at least one injector to stop injecting at least one of an alkaline substance and an acidic substance once the pH level reaches the desired value or range. In some embodiments, the alkaline substance includes sodium hydroxide, and the acidic substance includes sulfuric acid.

In some embodiments, the at least one sensor 139 of the chemical management system 130 can additionally or alternatively include a temperature sensor configured to detect a temperature of at least one of the recirculating fluid stream and the various components of the treatment system 100. Maintaining the temperature of the recirculating fluid stream and the various components of the treatment system 100 at a target temperature or within a range of a desired temperatures can improve the efficiency of the treatment system 100 by enabling the reactions of the EC reactor and improving their efficiency. The temperature sensor of the chemical management system 130 can be configured to be in communication with the temperature control system 170. The temperature sensor can instruct the temperature control system 170 to activate based at least in part upon detecting a temperature outside the desired temperature range, or to deactivate based at least in part upon detecting a temperature within the desired temperature range.

In some embodiments, the at least one sensor 139 of the chemical management system 130 can additionally or alternatively include a conductivity sensor configured to detect a conductivity level of the recirculating fluid stream. In some embodiments, the conductivity sensor can include a Condumax CLS21D sensor, commercially available from Endress+Hauser of Reinach, Switzerland, and/or similar sensors. The conductivity sensor can include a conductivity transmitter (CT) sensor configured to measure an alternating current of the recirculating fluid stream. Maintaining the conductivity level of the recirculating fluid stream at a threshold value can improve the efficiency of the treatment system 100 by enabling the reactions of the EC reactor and improving their efficiency. To maintain the conductivity level of the recirculating fluid stream at a target conductivity or within a desired range of conductivity, the conductivity sensor can be configured to be in communication with the at least one injector of the chemical management system 130 and instruct the at least one injector to inject an electrolyte substance into the recirculating fluid stream, thereby regulating the conductivity level of the recirculating fluid stream. The conductivity sensor can instruct the at least one injector of the chemical management system 130 to inject the electrolyte substance at least in part upon measuring a conductivity level outside the threshold value. The conductivity sensor can also be configured to monitor the resulting conductivity level and instruct the at least one injector to stop injecting the electrolyte substance once the conductivity level reaches a threshold value defining a target conductivity or one end of a desired range. The conductivity sensor can instruct the at least one injector of the chemical management system 130 to stop injecting the electrolyte substance at least in part upon measuring a conductivity level at or within the desired range. In other embodiments, the conductivity sensor can communicate with a controller. The controller can be configured to instruct the at least one injector of the chemical management system 130 to inject an electrolyte substance into the recirculating fluid stream, thereby regulating the conductivity level of the recirculating fluid stream at least in part upon receiving readings from the pH sensor. The conductivity sensor can communicate with the controller which in turn can instruct the at least one injector of the chemical management system 130 to inject an electrolyte substance at least in part upon measuring a conductivity level outside the conductivity threshold level. The conductivity sensor can also be configured to monitor the resulting conductivity level and communicate with the controller which in turn can instruct the at least one injector to stop injecting an electrolyte substance once the conductivity level reaches the desired value or range. In some embodiments, the electrolyte substance includes a sodium sulphate solution.

In some embodiments, the at least one sensor 139 of the chemical management system 130 includes a foam sensor configured to detect the presence and/or an amount of foam in the EC reactor container 140. The foam sensor can be configured to, for example, optically detect an elevation or level of foam in the EC reactor container 140. In some embodiments, the foam sensor includes an infrared beam sensor. In some embodiments, the infrared beam sensor can include at least one of an IFM Effector OGS280 infrared sensor, an IFM OGE 281 infrared receiver, commercially available from ifm electronic of Essen, Germany, and similar sensors and/or receivers. The infrared beam sensor can be positioned in a headspace (e.g., an overhead area) of the EC reactor container 140. Controlling the amount of foam inside the EC reactor container 140 at or within a desired range can improve the efficiency of the treatment system 100.

The foam sensor can be configured to be in communication with the at least one injector of the chemical management system 130 and instruct the at least one injector to inject an antifoam chemical into the recirculating fluid stream. Beneficially, this can improve the efficiency of the foam management system disclosed herein. The foam sensor can instruct the at least one injector of the chemical management system 130 to inject the antifoam chemical at least in part upon detecting a foam accumulation outside the desired value.

The foam sensor can also be configured to monitor the accumulation of foam inside the EC reactor container 140 and instruct the at least one injector to stop injecting the antifoam chemical, such as Antifoam AF, commercially available from Spectrum Chemical of Gardena, California, United States, and/or similar antifoam chemicals, once the foam accumulation inside the EC reactor container reaches a threshold value. The foam sensor can instruct the at least one injector of the chemical management system 130 to stop injecting the antifoam chemical at least in part upon measuring a foam accumulation at or within a desired range of foam height within the EC reactor. In other embodiments, the foam sensor can communicate with a controller. The controller can be configured to instruct the at least one injector of the chemical management system 130 to inject an antifoam chemical into the recirculating fluid stream. Beneficially, this can improve the efficiency of the foam management system disclosed herein. The foam sensor can communicate with the controller which in turn can instruct the at least one injector of the chemical management system 130 to inject an antifoam chemical at least in part upon detecting a foam accumulation outside the desired values (e.g., above a threshold height).

The foam sensor can also be configured to monitor the accumulation of foam inside the EC reactor container 140 and communicate with the controller which in turn can instruct the at least one injector to stop injecting an antifoam chemical once the accumulation of foam inside the EC reactor container 140 reaches the threshold value. The foam sensor can communicate with the controller which in turn can instruct the at least one injector of the chemical management system 130 to stop injecting an antifoam chemical at least in part upon measuring an accumulation of foam inside the EC reactor container 140 at or below a desired level or range. In some embodiments, the at least one chemical injector of the chemical management system 130 can be manually activated/deactivated by an operator. The foam sensor can be configured to provide an indication to the operator of a need to inject the antifoam chemical into the recirculating fluid stream at least in part upon detecting a foam accumulation inside the EC reactor container 140 outside the threshold value. Based at least in part upon the indication provided by the foam sensor, the operator can activate the at least one injector of the chemical management system 130

In some embodiments, the antifoam chemical includes Antifoam AF. Antifoam AF can include a mixture of water, dimethylpolysiloxane, polyethylene glycol stearate, Glycerides, C14-18, mono- and di, polyethylene glycol, and octamethylcyclotetrasiloxane. The percentage by weight of the Antifoam AF can be 55% to 75% water, 15% to 35% dimethylpolysiloxane, 3% to 7% polyethylene glycol stearate, 3% to 7% Glycerides, C14-18, mono- and di, 1% to 5% polyethylene glycol, and 1% to 5% octamethylcyclotetrasiloxane.

Upon flowing through the temperature control system 170 via the line segment 172, the recirculating fluid stream can flow through a second filtration system 190 that can be similar to filtration system 110. The filtration system 190 can be configured to filter solid material from the recirculating fluid stream. The filtration system 190 can include one or more filters, and one or more valves that can be configured to distribute the flow of the recirculating fluid stream through the filtration system 190. Beneficially, this can allow servicing of the filtration system 190 (e.g., replacing a filter) without interrupting the flow of the recirculating fluid stream along the filtration system 190.

The recirculating fluid stream can exit the filtration system 190 via a line segment 196 of the fluid circuit. The line segment 196 can be configured to direct the recirculating fluid stream into an electrochemical (EC) reactor container 140. The EC reactor container 140 can include an EC reactor area 146 having an EC reactor. The EC reactor can include at least one pair of electrodes (e.g., anode and cathode) that can be configured to generate a current between them. Each pair of electrodes can include at least two electrodes. The EC reactor can be configured to destroy at least some of the PFAS in the recirculating fluid stream as the recirculating fluid stream flows through the current generated by the at least one pair of electrodes. Upon flowing through the EC reactor, the recirculating fluid stream can exit the EC reactor container 140 via a line segment 194 of the fluid circuit, and most of the fluid within the EC reactor area 146 can continue along the recirculating fluid stream.

In some cases, the treatment system 100 can include two or more EC reactors connected in series and cascading upward for sequential treatment of the recirculating fluid stream. For example, the treatment system 100 can include a first reactor container and a second reactor container, which can be similar or identical to the reactor container 140. The second reactor container can be connected to the first reactor container via a line segment. In some cases, the second reactor container can be positioned downstream of the first reactor container. This can allow the fluid stream circulating through the treatment system 100 to be treated by both the first and second EC reactors. This can beneficially improve the performance of the treatment system 100 of destroying PFAS. Although reference is made to the treatment system including two EC reactors, the treatment system 100 can include more than or less than two EC reactors (e.g., one, three, four, five, etc.). Each additional EC reactor can be connected downstream of another EC reactor and treat the fluid stream or foam output of any upstream EC reactor.

The at least one pair of electrodes of the EC reactor can include an anode electrode and a cathode electrode. Further, at least one of the anode electrode and the cathode electrode can include a titanium suboxide material. In some embodiments, both the anode electrode and the cathode electrode include titanium suboxide. Beneficially, the use of titanium suboxide in the anode and/or cathode electrodes can improve the effectiveness of the EO reaction by enhancing electrical conductivity between the at least one pair of electrodes. In other embodiments, only the anode electrode may include titanium suboxide. In still other embodiments, only the cathode electrode may include titanium suboxide.

The EC reactor can include a plurality of vertically extending electrode tubes 197 and a distribution chamber 191 positioned at or near a top section of the vertically extending electrode tubes 197. The plurality of electrode tubes 197 can be arranged in an array. In one embodiment, the plurality of electrode tubes can be arranged in a 3×12 array configuration. In a 3×12 configuration, the EC reactor can include a total of thirty-six electrode tubes 197. The plurality of electrode tubes can be arranged in array configurations other than a 3×12 configuration, and include more than, or less than thirty-six electrode tubes 197. The distribution chamber 191 can be configured to distribute the recirculating fluid stream as it enters the reactor container 140 through line segment 196. The distribution chamber 191 can distribute the recirculating fluid stream so that the recirculating fluid stream flows through the plurality of electrode tubes 197. The electrode tubes 197 can include an inner electrode tube and an outer electrode tube. In some embodiments, the EC reactor includes thirty-six electrode tubes 197. In other embodiments, the EC reactor includes more than thirty-six electrode tubes 197. In still other embodiments, the EC reactor includes less than thirty-six electrode tubes 197. The inner electrode tube and the outer electrode tube can include at least one of an anode electrode and a cathode electrode. Each electrode tube 197 can include separate connection terminals for each of the anode electrode and the cathode electrode. For example, an EC reactor having thirty-six electrode tubes 197, can have seventy-two connection terminals. That is, one for every anode electrode and cathode electrode of the electrode tubes 197. The inner electrode tube can be disposed in a region inside the outer electrode tube. Further, the inner electrode tube and the outer electrode tube can be separated by a gap. In some embodiments, the gap can be between about 5 mm and 15 mm, or 10 mm or less. In other embodiments, the gap can be 10 mm or more. The inner electrode tube and the outer electrode tube can be configured to generate a current between them along the gap. The current applied to the inner electrode tube and the outer electrode tube can destroy at least some of the PFAS contained in the recirculating fluid stream as the recirculating fluid stream flows through the electrode tubes 197. After flowing into the EC reactor area 146 via the line segment 196 and distribution chamber 191, the recirculating fluid stream can flow through the electrode tubes 197. The recirculating fluid stream can enter the electrode tubes 196 at a top portion of the electrode tubes 197, and exit the electrode tubes 197 laterally at different portions of the electrode tubes 197 as the recirculating fluid stream flows downwardly through the electrode tubes 197. FIG. 1F illustrates how the recirculating fluid stream can flow through the electrode tubes 197. Vertical arrows 198 show the flow path of the recirculating fluid stream as the recirculating fluid stream enters the electrode tube 197. The recirculating fluid stream can enter the electrode tube 197 through a top portion of the electrode tube 197 and flow downwardly through the electrode tube 197 in the direction of the vertical arrows 198. The recirculating fluid stream entering the electrode tube 197 can exit the electrode tube 197 along lateral portions of the electrode tube 197. Horizontal arrows 199 illustrate the path of the recirculating fluid stream as it exits the electrode tube 197. After exiting the electrode tubes 197, the recirculating fluid stream can continue to flow through the flow recirculation system 120. The positive pressure generated by the various pumps of the flow recirculation system 120 can facilitate the flow of the recirculating fluid stream along the flow recirculation system 120 and its components, including the EC reactor and its electrode tubes 197.

The EC reactor can be configured to operate in a plurality of operational modes. For example, in a first operational mode, the EC reactor can be configured to produce an electrooxidation (EO) reaction. As another example, in a second operational mode, the EC reactor can be configured to produce an electroreduction (ER) reaction. The EC reactor can be configured to destroy at least a portion of the PFAS in the recirculating fluid stream when the EC reactor is in the first operational mode, e.g., the “EO mode”. The EC reactor can be configured to treat a byproduct, which can be harmful to human health and the environment, of the EC reactor produced during the first operational mode when the EC reactor is in the second operational mode, e.g., the “ER mode”. The byproduct of the EC reactor can include oxidized byproducts. The EC reactor can include a controller configured to automatically toggle between the multiple operational modes of the EC reactor. In some embodiments, the controller of the EC reactor automatically toggles between the multiple operational modes of the EC reactor based at least in part on a user-defined periodic schedule. The periodic schedule can define one or more periods of time when the EC reactor will operate in at least one of the first operational mode and the second operational mode. In other embodiments, the controller of the EC reactor automatically toggles between the multiple operational modes of the EC reactor based at least in part on the chemical properties of the recirculating fluid stream as detected by the at least one sensor 139 of the chemical management system 130. The chemical properties of the recirculating fluid stream can include at least one of a chemical concentration, a temperature, an electrical conductivity, an oxidation reduction potential, and a pH level. Beneficially, toggling between the plurality of operational modes of the EC reactor can improve the performance of the treatment system 100, facilitate maintenance of the EC reactor, and/or extend the longevity of the EC reactor. In other embodiments, the treatment system 100 can include separate recirculation system 120 including an initial recirculation system 120 operating in EO mode, and a subsequent second recirculation system 120 operating in ER mode, for the purpose of improving the performance and longevity of the system and enhance treatment of chemical byproducts.

The flow recirculation system 120 can also include a bypass. The bypass can be configured to allow servicing of a segment of the fluid circuit and any components placed along that segment without interrupting the flow of the recirculating fluid stream along the flow recirculation system 120. The bypass can include a plurality of valves 136, 138 that can be configured to redirect the flow of the recirculating fluid stream through the flow recirculation system 120. For example, valves 136 can be closed and valves 138 can be opened to direct the flow of the recirculating fluid stream through the line segment where valves 138 are located thereby allowing servicing of the line segment where valves 136 are located without interrupting the flow of the recirculating fluid stream along the flow recirculation system 120. Similarly, valves 138 can be closed and valves 136 can be opened to direct the flow of the recirculating fluid stream through the line segment where valves 136 are located thereby allowing servicing of the line segment where valves 138 are located without interrupting the flow of the recirculating fluid stream along the flow recirculation system 120.

The treatment system 100 can include a foam management system. The foam management system can be configured to regulate an amount of foam inside the EC reactor container 140. The foam management system can regulate the amount of foam inside the EC reactor container 140 by flowing at least a portion of the recirculating fluid stream from the bottom portion of the EC reactor container 140 to an overhead area of the EC reactor container 140, and dispensing the recirculating fluid stream over the EC reactor area 146. The foam management system can include a line segment 195 running from the EC reactor area 146 to the headspace (e.g., overhead area) of the EC reactor container 140 and a pump 142 which can facilitate flowing of the recirculating fluid stream from the bottom portion of the EC reactor container 140 to the headspace of the EC reactor container 140. At least a portion of the line segment 195 of the foam management system running from the EC reactor area 146 to an overhead area of the EC reactor container 140 can run outside the EC reactor container 140. The foam management system can also include at least one nozzle 144 positioned along a portion of the line segment 195 ending in the headspace of the of the EC reactor container 140. The nozzle 144 can be positioned vertically over a region of the EC reactor directly below. The nozzle 144 can be configured to dispense at least a portion of the recirculating fluid stream directly downward over the region of the EC reactor thereby reducing the amount of foam in the EC reactor container 140. The antifoam chemical injected to the recirculating fluid stream by the chemical management system 130 can improve the efficiency of the foam management system to reduce the amount of foam in the EC reactor container 140 as the nozzle 144 sprays a portion of the recirculating fluid stream over the EC reactor. The nozzle 144 can also impart lateral or horizontal components to the spray to reach foam near the EC reactor container 140 outer walls. The nozzle 144 can also be configured to dispense the portion of the recirculating fluid stream at different velocities, angles, and/or droplet sizes and mass. Beneficially, an overhead area of the EC reactor container 140 can allow foam buildup, drying, and collapse to a bottom portion of the EC reactor container 140. In some embodiments, the at least one nozzle 144 of the foam management system can be manually activated and/or deactivated by an operator. The foam sensor of the chemical management system 130 can be configured to provide an indication to the operator of a need to activate the at least one nozzle 144 at least in part upon detecting a foam accumulation inside the EC reactor container 140 outside the desired values. Based at least in part upon the indication provided by the foam sensor, the operator can activate the at least one nozzle 144.

The EC reactor container 140 can be in fluid communication with an air duct 192 and an exhaust air line 422. The air duct 192 can be configured to supply air from the atmosphere into the EC reactor container 140. The exhaust air line 422 can be in fluid communication with an exhaust management system and can be configured to flow exhaust gases from the EC reactor container 140 to the exhaust management system. The exhaust management system can be configured to capture any potential contaminants in the exhaust gases from the EC reactor container 140 before the exhaust gases are released into the atmosphere.

The treatment system can include an effluent line 148 that can be configured to remove an effluent fluid stream including at least a portion of the recirculating fluid stream from the flow recirculation system 120. A pump 162 can facilitate removal of the effluent fluid stream from the flow recirculation system 120 by pumping the effluent fluid stream through the effluent line 148.

The treatment system 100 can be configured to infuse the influent fluid stream, recirculate the recirculating fluid stream, and remove the effluent fluid stream at variable rates. Beneficially, this can modulate influent flow to improve destruction efficiency, and homogenize and condition the recirculation fluid stream prior to continual re-treatment. The variable rates can also reduce the risk of severe foam generation, as the higher-strength influent fluid stream can be immediately diluted and treated along with the recirculating fluid stream within the reactor. The reactor operating conditions and flow rates can be modified to suit the conditions of the fluid stream under treatment. For example, the treatment system 100 can infuse the influent fluid stream into the treatment system 100 at an average influent rate. In some embodiments, the average influent rate can be in a range of 0.3 liters per hour to 70 liters per hour, 1 liter per hour to 65 liters per hour, 5 liters per hour to 60 liters per hour, 10 liters per hour to 50 liters per hour, 15 liters per hour to 40 liters per hour, or 20 liters per hour to 30 liters per hour. Similarly, the treatment system 100 can remove the effluent fluid stream from the treatment system 100 at an average effluent rate. The average effluent rate can be in a range of 0.3 liters per hour to 70 liters per hour, 1 liter per hour to 65 liters per hour, 5 liters per hour to 60 liters per hour, 10 liters per hour to 50 liters per hour, 10 liters per hour to 40 liters per hour, or 20 liters per hour to 30 liters per hour. The treatment system 100 can recirculate the recirculating fluid stream at an average recirculation rate. The average recirculation rate can be in a range of 4,500 liters per hour to 18,000 liters per hour, 5,000 liter per hour to 17,000 liters per hour, 6,000 liters per hour to 16,000 liters per hour, 7,000 liters per hour to 15,000 liters per hour, 8,000 liters per hour to 14,000 liters per hour, 9,000 liters per hour to 13,000 liters per hour, or 10,000 liters per hour to 12,000 liters per hour. Thus, the average recirculation rate of the recirculating fluid stream can be sixty-four (64) times to sixty-six-thousand (66,000) times that of the average influent rate or the average effluent rate. Beneficially, the high ratio of average recirculation rate to average influent rate and/or average effluent rate maximizes destruction of the PFAS contained in the recirculating fluid stream. In some embodiments, the average influent rate and the average effluent rate are the same. That is, the amount of influent stream infused into the treatment system 100 is the same as the amount of effluent fluid stream removed from the treatment system 100.

FIG. 1B shows a schematic illustration of one embodiment of a filtration system. Line segment 104 can be configured to flow the influent fluid stream into the filtration system 110. The filtration system 110 can include a first filtration stage including one or more filters 112. The filtration system 110 can also include a second filtration stage having one or more filters 114. The filters 112, 114 can have a filter rating ranging from 5 microns (μm) to 10 microns (μm) thereby allowing the filtration system 110 to remove solid materials of various dimensions from the influent fluid stream. Like the bypass system of the flow recirculation system 120, the filtration system 110 can include a plurality of valves 111, 113, 115, 117 configured to redirect the flow of the influent fluid stream through the filtration system. For example, in the first filtration stage, valve 111 can be closed and valve 113 can be opened to direct the flow of the influent fluid stream through the line segment where valve 113 is located. Similarly, valve 113 can be closed and valve 111 can be opened to direct the flow of the influent fluid stream through the line segment where valve 111 is located. The second filtration stage can also include a bypass system similar to that of the first filtration stage. For example, in the second filtration stage, valve 115 can be closed and valve 117 can be opened to direct the flow of the influent fluid stream through the line segment where valve 117 is located. Similarly, valve 117 can be closed and valve 115 can be opened to direct the flow of the influent fluid stream through the line segment where valve 115 is located. The filtration system 110 can be configured so that the influent fluid stream exists the filtration system 110 via a line segment 116 of the flow recirculation system 120.

The second filtration system 190 can be configured similar to filtration system 110. A line segment of the fluid circuit can configured to flow the recirculation fluid stream into the filtration system 190. The filtration system 190 can include a first filtration stage including one or more filters. The filtration system 190 can also include a second filtration stage having one or more filters. The filters can have a filter rating ranging from 5 microns (μm) to 10 microns (μm) thereby allowing the filtration system 190 to remove solid materials of various dimensions from the recirculating fluid stream. Like the bypass system of the flow recirculation system 120, the filtration system 190 can include a plurality of valves configured to redirect the flow of the recirculating fluid stream through the fluid circuit. For example, in the first filtration stage, a first valve can be closed and a second valve can be opened to direct the flow of the recirculating fluid stream through the line segment where the second valve is located. Similarly, the first valve can be opened and the second valve can be closed to direct the flow of the recirculating fluid stream through the line segment where the first valve is located. The second filtration stage can also include a bypass system similar to that of the first filtration stage. For example, in the second filtration stage, a first valve can be closed and a second valve can be opened to direct the flow of the recirculating fluid stream through the line segment where the second valve is located. Similarly, the first valve can be opened and the second valve can be closed to direct the flow of the recirculating fluid stream through the line segment where the first valve is located. The filtration system 190 can be configured so that the recirculating fluid stream exists the filtration system 190 via a line segment 196 of the flow recirculation system 120.

FIG. 1C shows a schematic illustration of one embodiment of a chemical management system 130. The chemical management system 130 can be in fluid connection with the flow circuit of the flow recirculation system 120 and can be configured to automatically regulate the chemical properties of the recirculating fluid stream. The chemical properties of the recirculating fluid stream can include at least one of a chemical concentration, a temperature, an electrical conductivity, an oxidation reduction potential, and a pH level. The chemical management system 130 can include at least one sensor 139 and at least one injector. The chemical management system 130 can also include one or more chemical storage containers 132 that can be configured to store one or more chemicals. The one or more chemicals stored in the one or more chemical storage containers 132 can include at least one of sodium hydroxide, sulfuric acid, electrolytes, and an antifoam chemical. The injector of the chemical management system 130 can be configured to automatically inject one or multiple chemicals into the recirculating fluid stream. One or more pumps 134 can facilitate delivery of the one or more chemicals from the chemical management system 130 to the recirculating fluid stream by pumping the one or more chemicals stored in the one or more chemical storage containers 132 into the flow recirculation system 120. A static mixer 436 can be positioned along the fluid circuit of the flow recirculation system 120 and downstream of the chemical management system 130. The static mixer 436 can be configured to mix the chemical(s) injected by the injector of the chemical management system 130 and the recirculating fluid stream.

In some embodiments, the at least one sensor 139 of the chemical management system 130 includes a pH sensor configured to detect a pH level of the recirculating fluid stream. The pH sensor can include a pH transmitter (PHT) sensor configured to measure, at least one of a pH level, temperature, and oxidation reduction potential (ORP). In some embodiments, the PHT sensor can include an CPS16D sensor, commercially available from Endress+Hauser of Reinach, Switzerland, and/or similar sensors. Maintaining the pH level of the recirculating fluid stream at a target pH or within a range of desired pH values can improve the efficiency of the treatment system 100. The pH target value can be, for example, any value from 1 to 14. In some embodiments, the pH target value is 5 to 7. In other embodiments, the pH threshold value includes a desired range. The pH threshold value range can be, for example, from 5 to 7. To maintain the pH level of the recirculating fluid stream at a target value or within a desired range of pH, the at least one injector of the chemical management system 130 can automatically inject an alkaline substance, to increase the pH level of the recirculating fluid stream, or an acidic substance, to decrease the pH level of the recirculating fluid stream, thereby regulating the pH level of the recirculating fluid stream. In some embodiments, the alkaline substance includes sodium hydroxide, and the acidic substance includes sulfuric acid. The at least one injector of the chemical management system 130 can inject the alkaline substance or the acidic substance into the recirculating fluid stream upon receiving an instruction from the pH sensor that the pH level of the recirculating fluid stream is not at the target value or within the desired range.

FIG. 1D shows a schematic illustration of one embodiment of a temperature control system 170. The temperature control system 170 can be configured to regulate a temperature of the recirculating fluid stream as a line segment 172 of the flow recirculation system 120 passes through the temperature control system 170. The temperature control system 170 can include a circulating flow path 175, a temperature sensor, a temperature control pump 176, and one or more heat exchangers 174, 178. The temperature control sensor can be similar to the temperature sensor of the chemical management system 130. The temperature control pump 176 and the one or more heat exchangers 174, 178, can be positioned along the circulating flow path 175 of the temperature control system 170. The temperature control pump 176 can be configured to circulate a coolant along the circulating flow path 175 thereby regulating the temperature along the circulating flow path 175. The coolant can be any fluid that can serve to carry heat. In some embodiments, the coolant can include at least one of a glycol fluid, air, and water. Line segment 172 of the flow recirculation system 120 can be configured to pass through heat exchanger 174 of the temperature control system 170 thereby regulating the temperature of the recirculating fluid stream flowing through line segment 172. In some embodiments, the temperature sensor can activate/deactivate and control the operation of the temperature control system 170 based at least in part on the temperature of the recirculating fluid stream as measured by the temperature sensor.

FIG. 1E shows a schematic view of one embodiment of an electrochemical (EC) reactor container 140 and a foam management system. The EC reactor can include one or more electrode tubes 197. The one or more electrode tubes 197 can include at least one pair of electrodes positioned between 5 mm and 15 mm apart, or 10 mm or less from each other and configured to create a current between them. The at least one pair of electrodes can include at least two electrodes. The electrodes can include anode electrode and a cathode electrode. In other embodiments, the at least one pair of electrodes can be positioned 10 millimeters or more from each other. The at least one pair of electrodes can include at least one of an anode electrode and a cathode electrode of the titanium suboxide family. Line segment 196 of the flow recirculation system 120 can be configured to dispense the recirculating fluid stream into the EC reactor container 140. The EC reactor can be configured to destroy at least some of the PFAS in the recirculating fluid stream as the recirculating fluid stream flows through the EC reactor. For example, the recirculating fluid stream can flow through the one or more electrode tubes 197 where the current generated by the at least one pair of electrodes can destroy at least a portion of the PFAS contained in the recirculating fluid stream.

The foam management system can be configured to regulate an amount of foam generated by the EC reactor in the EC reactor container 140. The foam management system can include multiple tanks and pipes which can convey foam accumulating in the fluid holding tank into one or more successive foam management tanks with optical foam sensors. Each of the foam management tanks can apply one or more foam-breaking mechanisms which, for example, can include compressive action, foam separation and drying, mechanical breaking using fluid recirculating sprinklers, and/or foam-condensate recirculation into the fluid holding tank.

In some cases, the foam management system can include a line segment 195 running from a bottom area of the EC reactor container 140 to an overhead area of the EC reactor container 140. A pump 142 can facilitate the flow of a portion of the recirculating fluid stream along the line segment 195 running from the bottom area of the EC reactor to an overhead area of the EC reactor container 140. At least a portion of line segment 195 can run outside the EC reactor container 140. The foam management system can also include at least one nozzle 144 positioned along a portion of line segment 195 ending in the overhead area of the of the EC reactor. The nozzle 144 can be positioned vertically over a central region of the EC reactor directly below. The nozzle 144 can be configured to dispense the portion of the recirculating fluid stream flowing through line segment 195 directly downward over the central region of the EC reactor thereby reducing the amount of foam in the EC reactor container 140. The nozzle 144 can also impart lateral or horizontal components to the spray to reach foam near the EC reactor container 140 outer walls. The nozzle 144 can also be configured to dispense the portion of the recirculating fluid stream at different velocities, angles, and/or droplet sizes and mass. Beneficially, an overhead area of the EC reactor container 140 can allow foam buildup, drying, and collapse to a bottom portion of the EC reactor container 140.

The EC reactor container 140 can be in fluid communication with an air duct 192 and an exhaust air line 422. The air duct 192 can be configured to supply air from the atmosphere into the EC reactor container 140. The exhaust air line 422 can be in fluid communication with an exhaust management system and can be configured to flow exhaust gases from the EC reactor container 140 to an exhaust management system. The exhaust management system can be configured to reduce contaminants in the exhaust gases from the EC reactor container 140 before the exhaust gases are released into the atmosphere.

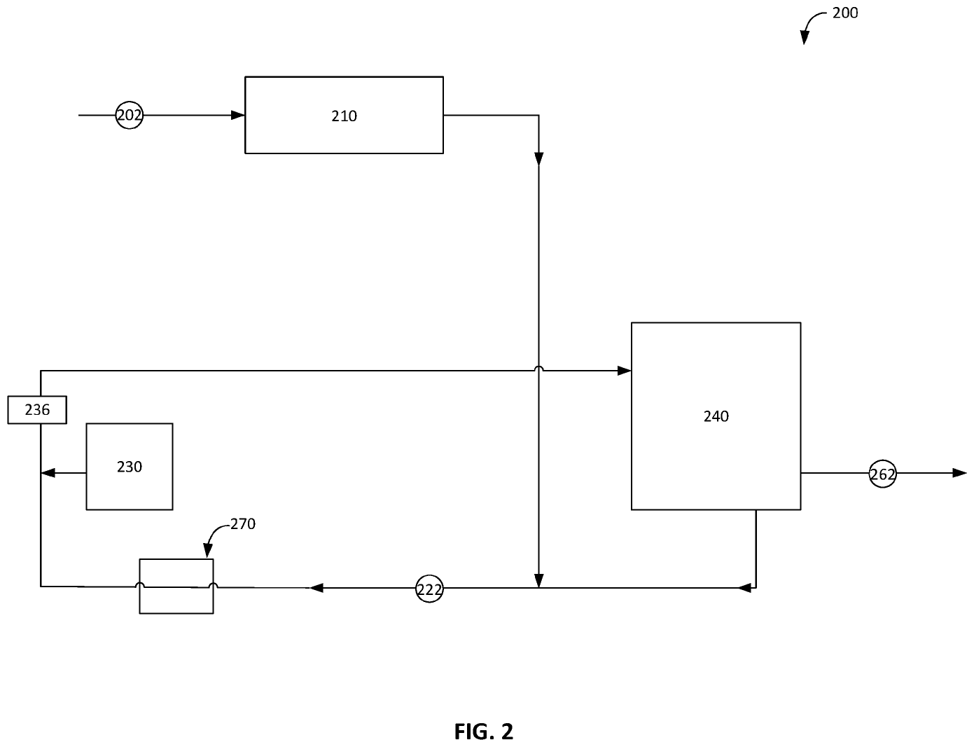

FIG. 2 shows a schematic illustration of one embodiment of a treatment system 200 for destroying PFAS contained in a fluid stream. The treatment system 200 can include at least one filtration system 210, a temperature control system 270, a chemical management system 230, a foam management system, an exhaust management system, and an electrochemical (EC) reactor.

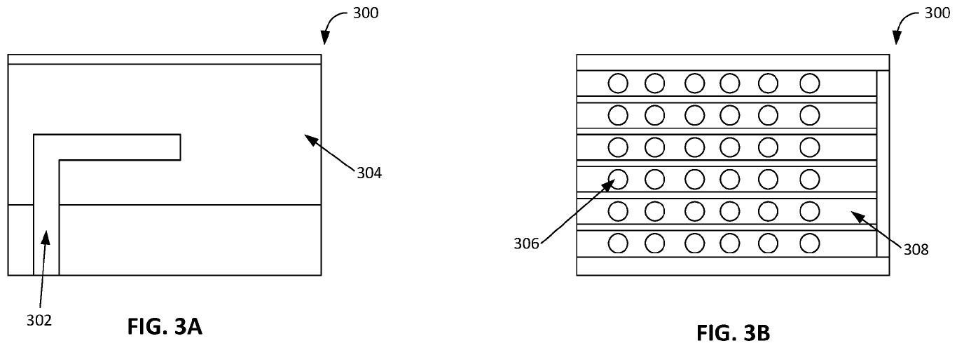

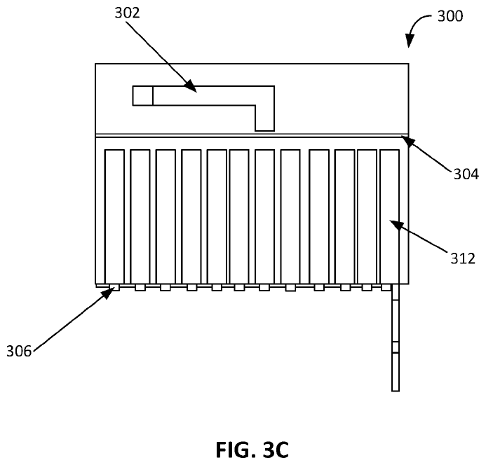

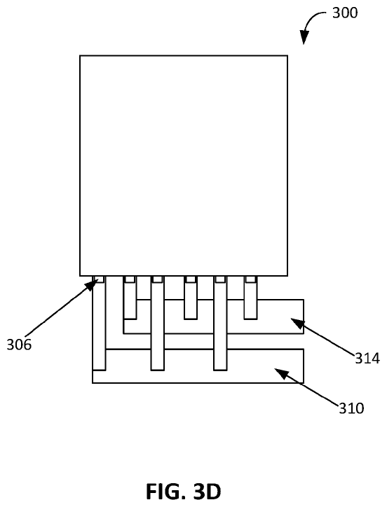

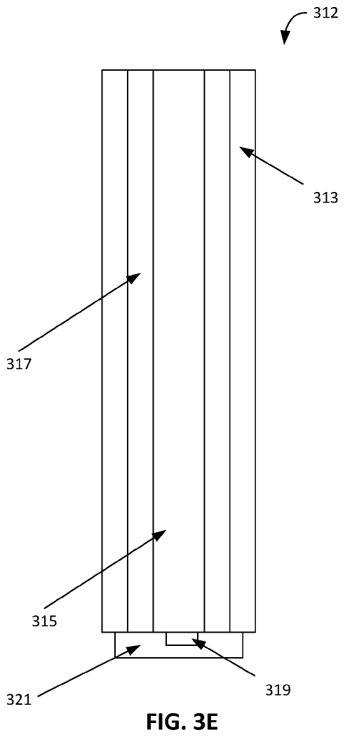

FIGS. 3A-D show various views of an embodiment of an electrochemical (EC) reactor container 300. FIG. 3A shows a top view of an embodiment of an EC reactor container 300. The EC reactor container 300 can include a line 302 configured to direct the recirculating fluid stream into a distribution chamber 304 to equalize the recirculation fluid pressure and flow prior to dispensing flow at an equal rate through each of the electrode tubes. A separate line can include a nozzle configured to dispense a portion of the recirculating fluid stream directly downward over the central region of the EC reactor container 300 thereby reducing the amount of foam in the EC reactor container 300. The nozzle can be positioned vertically over a central region of the EC reactor directly above and along the line 302.

FIG. 3B shows a bottom view of an embodiment of an EC reactor container 300. The EC reactor container can include a plurality of electrode connection terminals 306. The electrode connection terminals 306 can be configured to provide an electrical current to the electrodes of the EC reactor via a plurality of plates 308, including separate plates which connect multiple anodes together and multiple cathodes together. In some embodiments, the position of the of connection terminals 306 can match the position of the electrode tubes 312 inside the EC reactor container 300. In other embodiments, the position of the connection terminals 306 can be different than the position of the electrode tubes 312 inside the reactor container 300.

FIG. 3C shows a cross-section view of an embodiment of an EC reactor container 300. As previously mentioned, the EC reactor container 300 can include a line 302 configured to direct the recirculating fluid stream into a distribution chamber 304 to equalize the recirculation fluid pressure and flow prior to dispensing flow at an equal rate through each of the electrode tubes. A separate line can include a nozzle configured to dispense a portion of the recirculating fluid stream directly downward over the central region of the EC reactor container 300 thereby reducing the amount of foam in the EC reactor container 300. The nozzle can be positioned vertically over a central region of the EC reactor directly above and along the line segment 302. FIG. 3C also shows the plurality of electrode connection terminals 306. The EC reactor container 300 can also include one or more electrode tubes 312 configured to destroy at least some of the PFAS in the recirculating fluid stream as the recirculating fluid stream flows through the EC reactor. The plurality of electrode connection terminals 306 can include separate connection terminals for each of the anode electrode and the cathode electrode of the one or more electrode tubes 312.

FIG. 3D shows a side view of an embodiment of an EC reactor container 300. The EC reactor container can include at least one connection terminal 306 configured to provide an electrical current to the electrodes of the EC reactor via a plurality of plates 308, 310, 314. In some embodiments, the plurality of plates 308, 310, 314 can serve as electrical bus bars to connect to respective anode and cathode electrodes of each tubular electrode 312. The plurality of plates 308, 310, 314 can be connected to a power source. The power source can include a rectifier.

FIG. 3E shows a cross section view of an embodiment of an electrode tube 312. The electrode tube 312 can be disposed inside an EC reactor container 300. The electrode tube 312 can include an inner electrode tube 315 and an outer electrode tube 313. Inner electrode tube 315 and outer electrode tube 313 can include at least one of an anode electrode and a cathode electrode. The inner electrode tube 315 can be disposed in a region inside the outer electrode tube 313. Further, the inner electrode tube 315 and the outer electrode tube 313 can be separated by a gap 317. The inner electrode tube 315 and the outer electrode tube 313 can be configured to generate a current between them along gap 317. The current applied to the inner electrode tube 315 and the outer electrode tube 313 can destroy at least some of the PFAS contained in the recirculating fluid stream as the recirculating fluid stream flows through the electrode tube 312. The electrode tube 312 can also include a pair of electrical connections 319, 321 disposed on same side of the electrode tube 312. The electrical connections 319, 321 can be configured to allow an electrical current to flow through the electrode tube 312 thereby allowing the electrode tube 312 to generate a current between the inner electrode tube 315 and the outer electrode tube 313.

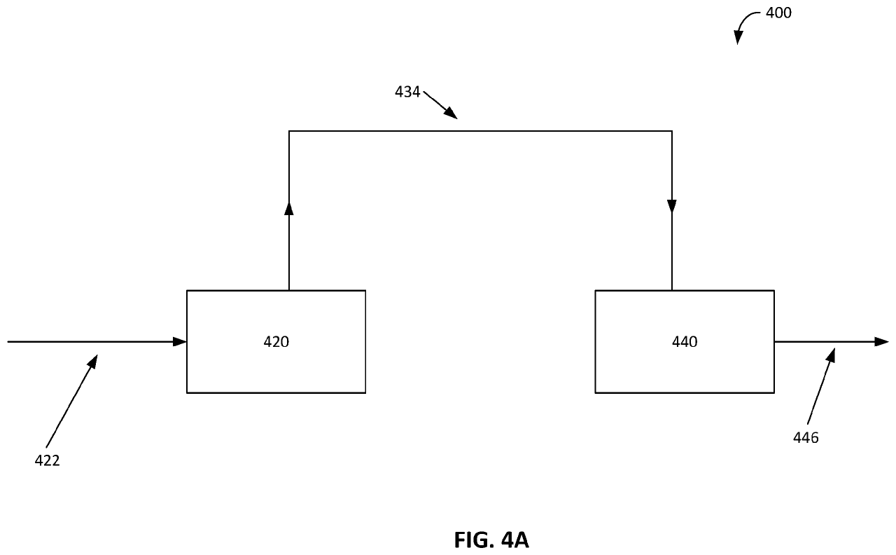

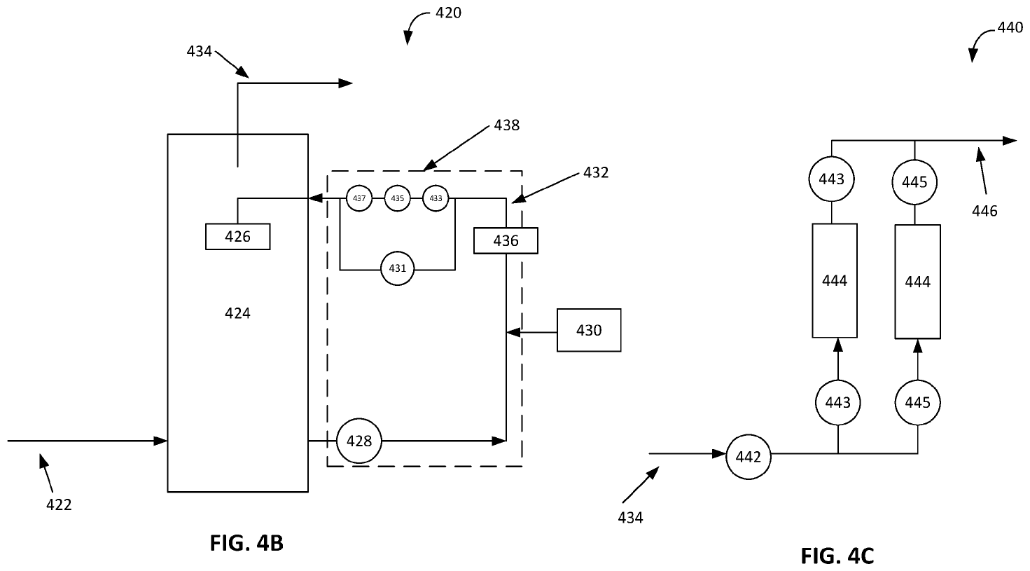

FIG. 4A shows a schematic view of an embodiment of an exhaust management system 400 having a scrubber 420 and a granular activated carbon (GAC) system 440. The exhaust management system 400 can be configured to capture potential contaminants in exhaust gases from the EC reactor container before the exhaust gases are released into the atmosphere. At least a portion of the exhaust gases from the EC reactor can exit the EC reactor via a line segment 422. The line segment 422 can flow the exhaust gases from the EC reactor container into the scrubber 420 of the exhaust management system. The scrubber 420 can be configured to remove at least a portion of acidic gases contained in the exhaust gas as the exhaust gas flows through the scrubber 420. The acidic gases can include, for example, gases such as hydrogen fluoride and hydrogen chloride, which can be neutralized by contact with a caustic scrubbing solution containing a hydroxide ion. The line segment 434 can be configured to flow the exhaust gas from the scrubber 420 to the GAC system 440. The GAC system 440 can be configured to remove at least one organic compound contained in the exhaust gas as the exhaust gas flows through the GAC system 440. Line segment 446 can be configured to flow the exhaust gas from the GAC system 440 to the atmosphere after the exhaust gas flows through the GAC system 440.

FIG. 4B shows a schematic view of an embodiment of scrubber 420 of exhaust system 400. At least a portion of the exhaust gases from the EC reactor can exit the EC reactor via a line segment 422. The line segment 422 can flow the exhaust gases from the EC reactor container into the scrubber 420 of the exhaust management system 400. The scrubber can include a scrubber container 424. The exhaust gases from the EC reactor container can flow from a bottom portion of the scrubber container 424 to a top portion of the scrubber container 424 and exit the scrubber container 424 via a line segment 434. A nozzle 426 disposed inside the scrubber container 424 can be configured to dispense an alkaline substance in a direction opposite the flow of the exhaust gas. For example, the nozzle 426 can dispense the alkaline substance from a top portion of the scrubber container 424 vertically downward towards a bottom portion of the scrubber container 424. The scrubber 420 can be configured to remove at least a portion of acidic gases from the exhaust gas of the EC reactor as the exhaust air flows through the scrubber container 420.

The scrubber 420 can also include a recirculation system 438 for recirculating the alkaline substance through the scrubber 420. The recirculation system 438 can be configured to flow the alkaline substance from a bottom area of the scrubber container 424 to the nozzle 426. The recirculation system 438 can include a scrubber pump 428 configured to flow the alkaline substance through the recirculation system. A chemical management system 430, similar to chemical system 130, can be in fluid communication with the recirculation system 438 and can be configured to store the alkaline substance and supply the same to the recirculation system 438. A static mixer 436 can be placed along the recirculation system and downstream of the chemical management system 430. The alkaline substance can flow from the chemical management system 430 to the nozzle 426 of the scrubber container via a line segment 432.

The recirculation system 438 of the scrubber 420 can include a bypass similar to that of the bypass in the recirculation system 120. The bypass can be configured to allow servicing of a segment of the recirculation system 438 and any components placed therein without interrupting the flow of the alkaline substance along the recirculation system 438. The bypass can include a plurality of valves 431, 433, 437 that can be configured to redirect the flow of the alkaline substance through the recirculation system 438. For example, valve 431 can be closed and valves 433, 437 can be opened to direct the flow of the alkaline substance through the line segment where valves 433, 437 are located thereby allowing servicing of the line segment where valves 431 is located without interrupting the flow of the alkaline substance along the recirculation system 438. Similarly, valves 433, 437 can be closed and valve 431 can be opened to direct the flow of the alkaline substance through the line segment where valve 431 is located thereby allowing servicing of the line segment where valves 433, 437 are located without interrupting the flow of the alkaline substance along the recirculation system 438. The recirculation system 438 can also include a sensor 435 configured to detect an alkaline concentration of the alkaline substance.

FIG. 4C shows a schematic view of an embodiment of GAC system 440 of exhaust management system 400. Line segment 434 can be configured to flow the exhaust gas from the scrubber 420 to the GAC system 440. The GAC system 440 can include a pump 442 configured to facilitate the flow of the exhaust from the scrubber 420 to the GAC system 440. The GAC system can also include one or more filters 444 configured to remove at least one organic compound contained in the exhaust gas. The GAC system 440 can include a plurality of valves 443, 445 configured to direct the flow of exhaust gas through the one or more filters 444. For example, valves 443 can be closed and valves 445 can be opened to direct the flow of exhaust gas along the filter 444 where valves 445 are located. Similarly, valves 445 can be closed and valves 443 can be opened to direct the flow of exhaust gas along the filter 444 where valves 443 are located. The exhaust gas can exit the GAC system via a line segment 446.

Methods of destroying PFAS in a fluid stream using a treatment system having an EC reactor are also disclosed herein. Any of the methods described herein can incorporate the systems for destroying at least one of a perfluoro and polyfluoroalkyl substance (PFAS) contained in an influent fluid stream using an electrochemical (EC) reactor also disclosed herein. A method of destroying at least one of a perfluoroalkyl and polyfluoroalkyl substance (PFAS) contained in an influent fluid stream can include the steps of flowing the influent fluid stream into a treatment system at an average influent rate; flowing a recirculating fluid stream through a recirculation system having an electrochemical (EC) reactor configured to destroy at least some of the PFAS in the recirculating fluid stream as the recirculating fluid stream flows through the EC reactor at an average recirculation rate; and removing an effluent fluid stream including a portion of the recirculating fluid stream from the recirculation system at an average effluent rate. The average recirculation rate can be higher than at least one of the average influent rate and the average effluent rate. For example, the average influent rate can be in a range of 0.3 liters per hour to 70 liters per hour, 1 liter per hour to 65 liters per hour, 5 liters per hour to 60 liters per hour, 10 liters per hour to 50 liters per hour, 15 liters per hour to 40 liters per hour, or 20 liters per hour to 30 liters per hour. The average effluent rate can be in a range of 0.3 liters per hour to 70 liters per hour, 1 liter per hour to 65 liters per hour, 5 liters per hour to 60 liters per hour, 10 liters per hour to 50 liters per hour, 10 liters per hour to 40 liters per hour, or 20 liters per hour to 30 liters per hour. The average recirculation rate can be in a range of 4,500 liters per hour to 18,000 liters per hour, 5,000 liter per hour to 17,000 liters per hour, 6,000 liters per hour to 16,000 liters per hour, 7,000 liters per hour to 15,000 liters per hour, 8,000 liters per hour to 14,000 liters per hour, 9,000 liters per hour to 13,000 liters per hour, or 10,000 liters per hour to 12,000 liters per hour. Flowing the recirculating fluid stream through the recirculation system can include continuously flowing the recirculating fluid stream through the EC reactor.

A method of destroying at least one of a perfluoroalkyl and polyfluoroalkyl substance (PFAS) contained in an influent fluid stream can include the steps of flowing the influent fluid stream into a treatment system; flowing a recirculating fluid stream through a recirculation system having an electrochemical (EC) reactor; operating the EC reactor in a first operational mode to destroy at least some of the PFAS in the recirculating fluid stream as the recirculating fluid stream flows through the EC reactor; automatically switching the EC reactor to a second operational mode using a controller to treat a byproduct generated by the EC reactor; and removing an effluent fluid stream including a portion of the recirculating fluid stream from the recirculation system. The method can further include automatically switching the EC reactor from the first operational mode to the second operational mode using a controller. The first operational mode and the second operational mode of the EC reactor can include at least one of an electrooxidation (EO) operational mode and an electroreduction (ER) operational mode.

A method of destroying at least one of a perfluoroalkyl and polyfluoroalkyl substance (PFAS) contained in an influent fluid stream can include the steps of flowing the influent fluid stream into a treatment system at an average influent rate; destroying at least some of the PFAS in a recirculation fluid stream by flowing the recirculating fluid stream through a recirculation system having an electrochemical (EC) reactor; removing an effluent fluid stream including a portion of the recirculating fluid stream from the recirculation system at an average effluent rate; and regulating a temperature of the recirculating fluid stream with a temperature control system having a chiller. The chiller can be configured to regulate a temperature of the recirculating fluid stream as the recirculating fluid stream flows through a heat exchanger of the chiller. Regulating the temperature of the recirculating fluid stream can include running a segment of the recirculation system through a heat exchanger of the chiller. The method can further include pumping a coolant along a circulating flow path of the chiller.

A method of destroying at least one of a perfluoroalkyl and polyfluoroalkyl substance (PFAS) contained in an influent fluid stream can include the steps of flowing the influent fluid stream into a treatment system at an average influent rate; flowing a recirculating fluid stream through a recirculation system having an electrochemical (EC) reactor; operating the EC reactor to destroy at least some of the PFAS in the recirculating fluid stream; removing an effluent fluid stream including a portion of the recirculating fluid stream from the recirculation system at an average effluent rate; and automatically regulating at least one fluid property of the recirculating fluid stream using a chemical treatment system. Regulating the at least one fluid property of the recirculating fluid stream includes using at least one sensor to detect at least one of a chemical concentration, a temperature, a conductivity, and a pH level of the recirculating fluid stream. The method can further include injecting at least one chemical into the recirculating fluid stream at least in part upon receiving a signal from the at least one sensor.

A method of destroying at least one of a perfluoroalkyl and polyfluoroalkyl substance (PFAS) contained in an influent fluid stream can include the steps of flowing the influent fluid stream into a treatment system at an average influent rate; flowing a recirculating fluid stream through a recirculation system having an electrochemical (EC) reactor; operating the EC reactor to destroy at least some of the PFAS in the recirculating fluid stream; removing an effluent fluid stream including a portion of the recirculating fluid stream from the recirculation system at an average effluent rate; and reducing an amount of foam generated by the EC reactor by dispensing an a portion of the recirculating fluid stream directly downward over a central region of the EC reactor using an overhead nozzle positioned vertically over the central region of the EC reactor.

Unless the context clearly requires otherwise, throughout the description and the claims, the words “comprise,” “comprising,” “include,” “including” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Moreover, as used herein, when a first element is described as being “on” or “over” a second element, the first element may be directly on or over the second element, such that the first and second elements directly contact, or the first element may be indirectly on or over the second element such that one or more elements intervene between the first and second elements. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments.

While certain embodiments have been described, these embodiments have been presented by way of example only, and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. Any suitable combination of the elements and acts of the various embodiments described above can be combined to provide further embodiments. The accompanying claims and their equivalents are intended to cover such forms or modifications as would fall within the scope and spirit of the disclosure.

What is claimed is:

1. A treatment system for destroying at least one of a perfluoroalkyl and polyfluoroalkyl substance (PFAS) contained in an influent fluid stream, the system comprising:
an influent pump configured to pump the influent fluid stream into the treatment system;
a flow recirculation system including a fluid circuit through which a recirculating fluid stream flows, the flow recirculation system comprising:
an electrochemical (EC) reactor comprising at least one pair of electrodes including an anode electrode and a cathode electrode, the EC reactor configured to switch between a first operational mode and a second operational mode, wherein when the EC reactor is in the first operational mode, a current generated between the anode electrode and the cathode electrode destroys at least some of the PFAS in the recirculating fluid stream as the recirculating fluid stream flows through the EC reactor,
a foam management system comprising at least one overhead nozzle positioned vertically over a center region of the EC reactor and configured to dispense a portion of the recirculating fluid stream vertically downward toward the EC reactor to reduce an amount of foam in a container of the EC reactor,
a chemical management system comprising at least one injector and at least one sensor in communication with the injector, wherein the at least one injector is configured to inject a chemical into the recirculating fluid stream based at least in part upon a signal received from the at least one sensor,
a temperature control system comprising a chiller and configured to regulate a temperature of the recirculating fluid stream, and
a recirculation pump configured to pump the recirculating fluid stream through the flow recirculation system; and
an effluent pump configured to pump an effluent fluid stream comprising a portion of the recirculating fluid stream out of the flow recirculation system along an effluent line.

2. The treatment system of claim 1, wherein the influent pump pumps the influent fluid stream into the treatment system at an average influent flow rate, the recirculation pump pumps the recirculating fluid stream at an average recirculation rate, the effluent pump pumps the effluent fluid stream out of the recirculation flow system at an average effluent rate, and wherein the average recirculation rate is higher than at least one of the average influent flow rate and the average effluent rate.

3. The treatment system of claim 1, further comprising a filtration system including at least one filter configured to filter solid material from the influent fluid stream.

4. The treatment system of claim 1, wherein the anode electrode comprises a titanium suboxide.

5. The treatment system of claim 1, wherein the cathode electrode comprises a titanium suboxide.

6. The treatment system of claim 1, wherein the influent fluid stream comprises wastewater, surface water, drinking water, groundwater, or a mixture thereof.

7. The treatment system of claim 1, wherein the first operational mode of the EC reactor comprises an electrooxidation reaction.

8. The treatment system of claim 1, wherein the second operational mode of the EC reactor comprises an electroreduction reaction.

9. The treatment system of claim 1, wherein the EC reactor further comprises a controller configured to automatically toggle between the first operational mode of the EC reactor and the second operational mode of the EC reactor.

10. The treatment system of claim 1, wherein a byproduct is created as the recirculating fluid stream flows through the EC reactor when the EC reactor is in the first operational mode, and wherein the EC reactor is further configured to treat the byproduct when the EC reactor is in the second operational mode.

11. The treatment system of claim 1, wherein the chiller of the temperature control system comprises a circulating flow path, a chiller pump along the circulating flow path, a coolant, and a heat exchanger along the circulating flow path, wherein the fluid circuit of the flow recirculation system is configured to pass through the heat exchanger of the chiller thereby regulating a temperature of the fluid circuit.

12. The treatment system of claim 11, wherein the chiller pump is configured to pump the coolant through the circulating flow path.

13. The treatment system of claim 1, further comprising an exhaust management system in fluid communication with the flow recirculation system and including a circuit through which an exhaust gas stream flows, the exhaust management system comprising,
a granular activated carbon (GAC) treatment system comprising a plurality of filters in parallel and configured to remove at least one organic compound contained in the exhaust gas stream, and
a scrubber configured to dispense an alkaline fluid in a direction opposite the flow of the exhaust gas stream to remove acid gases contained in the exhaust gas stream.

14. The treatment system of claim 1, wherein the average recirculation rate of the recirculating fluid stream is in a range of 4500 liters per hour to 18,000 liters per hour.

15. The treatment system of claim 1, wherein at least one of the average influent rate of the influent fluid stream and the average effluent rate of the effluent fluid stream is in a range of 0.3 liters per hour to 70 liters per hour.

16. The treatment system of claim 1, wherein the average recirculation rate of the recirculating fluid stream is sixty-four times to sixty-thousand times that of at least one of the average influent rate of the influent fluid stream and the average effluent rate of the effluent fluid stream.

17. The treatment system of claim 1, wherein the chemical injected into the recirculating fluid stream by the injector of the chemical management system includes at least one of sodium hydroxide, sulfuric acid, electrolytes, and antifoam chemical.

18. The treatment system of claim 1, wherein the foam management system further comprises at least one foam sensor, wherein the foam sensor is in communication with the at least one injector of the chemical management system and the least one overhead nozzle and configured to instruct the at least one injector of the chemical management system to inject an antifoam chemical into the recirculating fluid stream at least in part upon receiving an instruction from the at least one foam sensor, and further configured to instruct the at least one overhead nozzle to dispense the portion of the recirculating fluid stream based at least in part upon receiving an instruction from the at least one foam sensor.

19. The treatment system of claim 18, wherein the at least one foam sensor is configured to detect an amount of foam in the container of the EC reactor and to send an instruction to the at least one injector of the chemical management system and/or the at least one overhead nozzle when the amount of foam exceeds a predefined threshold.

20. The treatment system of claim 1, wherein the EC reactor is disposed inside a container.

21. The treatment system of claim 1, wherein the flow recirculation system further comprises a static mixer positioned along the fluid circuit of the flow recirculation system and downstream of the at least one injector of the chemical management system.

22. The treatment system of claim 1, further configured to operate in at least one of a batch mode and a continuous flow mode.

23. The treatment system of claim 1, wherein one of the anode electrode and the cathode electrode comprises an outer tube and the other of the anode electrode and the cathode electrode comprises an inner tube positioned inside the outer tube, and wherein the inner tube and the outer tube are separated by a gap.

24. The treatment system of claim 23, wherein the recirculating fluid stream flows through the gap separating the inner tube and the outer tube.

25. The treatment system of claim 1, wherein the nozzle is further configured to impart a lateral component to the portion of the recirculating fluid stream.

26. The treatment system of claim 1, further comprising a second EC reactor connected to and positioned downstream of the EC reactor and configured to receive at least one of a portion of a fluid stream output or the foam from the EC reactor.

27. A treatment system for destroying at least one of a perfluoroalkyl and polyfluoroalkyl substance (PFAS) contained in an influent fluid stream, the system comprising:
an influent line configured to supply the influent fluid stream to the treatment system;
a flow recirculation system including a fluid circuit through which a recirculating fluid stream flows, the flow recirculation system comprising an electrochemical reactor (EC) configured to destroy at least some of the PFAS in the recirculating fluid stream as the recirculating fluid stream flows through the EC reactor; and
an effluent line configured to remove an effluent fluid stream comprising a portion of the recirculating fluid stream from the flow recirculation system along the effluent line.

28. The treatment system of claim 27, wherein an average recirculation rate of the recirculating fluid stream is higher than at least one of an average influent flow rate of the influent fluid stream and an average effluent rate of the effluent fluid stream.

29. A treatment system for destroying at least one of a perfluoroalkyl and polyfluoroalkyl substance (PFAS) contained in an influent fluid stream, the system comprising:
an electrochemical (EC) reactor configured to operate in a plurality of operational modes, the EC reactor comprising,
at least one pair of electrodes including an anode electrode and a cathode electrode configured to destroy at least some of the PFAS in a recirculating fluid stream as the recirculating fluid stream flows through the EC reactor; and
a controller configured to automatically toggle between the plurality of operational modes of the EC reactor.

30. The treatment system of claim 29, further comprising a flow recirculation system including a fluid circuit through which the recirculating fluid stream flows.

31. The treatment system of claim 29, wherein the plurality of operational modes of the EC reactor includes at least one of an electrooxidation (EO) operational mode and an electroreduction (ER) operational mode.

32. A treatment system for destroying at least one of a perfluoroalkyl and polyfluoroalkyl substance (PFAS) contained in an influent fluid stream, the system comprising:
a flow recirculation system including a fluid circuit through which a recirculating fluid stream flows, the flow recirculation system comprising:
an electrochemical (EC) reactor configured to destroy at least some of the PFAS in the recirculating fluid stream as the recirculating fluid stream flows through the EC reactor; and
a chemical management system in fluid connection with the flow recirculation system and comprising at least one sensor and at least one injector,
wherein the at least one injector is configured to inject a chemical into the flow recirculation system at least in part upon receiving an instruction from the at least one sensor, and
wherein the at least one sensor is configured to detect at least one fluid property of the recirculating fluid stream.

33. The treatment system of claim 32, wherein the at least one fluid property of the recirculating fluid stream comprises at least one of a chemical concentration, a temperature, a conductivity, a pH level, and the presence of foam.

34. The treatment system of claim 32, wherein the at least one sensor of the chemical management system comprises a concentration sensor configured to detect an amount of a chemical in the recirculating fluid stream.

35. The treatment system of claim 32, wherein the at least one sensor of the chemical management system comprises a temperature sensor configured to detect a temperature of the recirculation fluid stream.

36. The treatment system of claim 32, wherein the at least one sensor of the chemical management system comprises a conductivity sensor configured to detect a conductivity of the recirculation fluid stream.

37. The treatment system of claim 32, wherein the at least one sensor of the chemical management system comprises a pH sensor configured to detect at least one of an acidity and alkalinity of the recirculation fluid stream.

38. The treatment system of claim 32, wherein the one sensor of the chemical management system comprises a foam sensor configured to detect the presence of foam in the container of the EC reactor.

39. A treatment system for destroying at least one of a perfluoroalkyl and polyfluoroalkyl substance (PFAS) contained in an influent fluid stream, the system comprising:
a flow recirculation system including a fluid circuit through which a recirculating fluid stream flows, the flow recirculation system comprising,
an electrochemical (EC) reactor configured to destroy at least some of the PFAS in the recirculating fluid stream as the recirculating fluid stream flows through the EC reactor; and
a temperature control system comprising a chiller, the temperature control system configured to regulate a temperature of the recirculating fluid stream.

40. The treatment system of claim 39, wherein the chiller of the temperature control system comprises a circulating flow path, a temperature control pump along the circulating flow path, a coolant, and a heat exchanger along the circulating flow path, wherein the fluid circuit of the flow recirculation system is configured to pass through the heat exchanger of the chiller thereby regulating a temperature of the fluid circuit.

41. The temperature control system of claim 40, wherein the temperature control pump is configured to pump the coolant through the circulating flow path.

42. A treatment system for destroying at least one of a perfluoroalkyl and polyfluoroalkyl substance (PFAS) contained in an influent fluid stream, the system comprising:
an electrochemical (EC) reactor configured to destroy at least some of the PFAS in the recirculating fluid stream as the recirculating fluid stream flows through the EC reactor; and
a foam management system comprising at least one overhead nozzle positioned vertically over a central region of the EC reactor and configured to dispense a portion of the recirculating fluid stream vertically downward over the EC reactor to reduce an amount of foam generated by the EC reactor.

43. The treatment system of claim 42, wherein the EC reactor is disposed inside a container.

44. The treatment system of claim 42, further comprising a flow recirculation system including a fluid circuit through which the recirculating fluid stream flows.

45. A treatment system for destroying at least one of a perfluoroalkyl and polyfluoroalkyl substance (PFAS) contained in an influent fluid stream, the system comprising:
a flow recirculation system including a fluid circuit through which a recirculating fluid stream flows, the flow recirculation system comprising,
an electrochemical (EC) reactor configured to destroy at least some of the PFAS in the recirculating fluid stream as the recirculating fluid stream flows through the EC reactor; and
an exhaust management system in fluid communication with the flow recirculation system and including a circuit through which an exhaust gas stream flows.

46. The treatment system of claim 45, wherein the exhaust management system further comprises:
a granular activated carbon (GAC) treatment system comprising a plurality of filters in parallel and configured to remove at least one organic compound contained in the exhaust gas stream, and
a scrubber configured to dispense an alkaline fluid in a direction opposite the flow of the exhaust gas stream to remove acid gases contained in the exhaust gas stream.

47. A treatment system for destroying at least one of a perfluoroalkyl and polyfluoroalkyl substance (PFAS) contained in an influent fluid stream, the system comprising:
a flow recirculation system including a fluid circuit through which a recirculating fluid stream flows, the flow recirculation system comprising,
an electrochemical (EC) reactor having an array of vertically extending electrode pairs and configured to destroy at least some of the PFAS in the recirculating fluid stream as the recirculating fluid stream continuously flows through the EC reactor;
wherein the EC reactor is disposed in a container configured to be transported from a first location to a second location.

48. The treatment system of claim 47, wherein the container is transported from the first location to the second location via at least one of a truck, a ship, a train, or a plane.

49. The treatment system of claim 47, wherein the electrode pairs of the array of vertically extending electrode pairs are spaced less than 100 millimeters apart.

50. The treatment system of claim 47, wherein the electrode pairs of the array of vertically extending electrode pairs are spaced less than 50 millimeters apart.

51. The treatment system of claim 47, wherein the electrode pairs of the array of vertically extending electrode pairs are spaced less than 10 millimeters apart.

52. The treatment system of claim 47, wherein the length of the container is 50 feet or less.

53. The treatment system of claim 47, wherein the length of the container is 35 feet or less.

54. The treatment system of claim 47, wherein the length of the container is 20 feet or less.

55. A method of destroying at least one of a perfluoroalkyl and polyfluoroalkyl substance (PFAS) contained in an influent fluid stream, the method comprising:
flowing the influent fluid stream into a treatment system at an average influent rate;
flowing a recirculating fluid stream through a recirculation system having an electrochemical (EC) reactor configured to destroy at least some of the PFAS in the recirculating fluid stream as the recirculating fluid stream flows through the EC reactor at an average recirculation rate; and
removing an effluent fluid stream comprising a portion of the recirculating fluid stream from the recirculation system at an average effluent rate.

56. The method of claim 55, wherein the average recirculation rate is higher than at least one of the average influent rate and the average effluent rate.

57. The method of claim 55, wherein flowing the recirculating fluid stream through the recirculation system comprises continuously flowing the recirculating fluid stream through the EC reactor.

58. The method of claim 55, wherein the average recirculation rate of the recirculating fluid stream is in a range of 4500 liters per hour to 18,000 liters per hour.

59. The method of claim 55, wherein at least one of the average influent rate of the influent fluid stream and the average effluent rate of the effluent fluid stream is in a range of 0.3 liters per hour to 70 liters per hour.

60. The method of claim 55, wherein the average recirculation rate of the recirculating fluid stream is sixty-four times to sixty-six-thousand times that of at least one of the average influent rate of the influent fluid stream and the average effluent rate of the effluent fluid stream.

61. A method of destroying at least one of a perfluoroalkyl and polyfluoroalkyl substance (PFAS) contained in an influent fluid stream, the method comprising:
flowing the influent fluid stream into a treatment system;
flowing a recirculating fluid stream through a recirculation system having an electrochemical (EC) reactor;
operating the EC reactor in a first operational mode to destroy at least some of the PFAS in the recirculating fluid stream as the recirculating fluid stream flows through the EC reactor;
automatically switching the EC reactor to a second operational mode using a controller to treat a byproduct generated by the EC reactor; and
removing an effluent fluid stream comprising a portion of the recirculating fluid stream from the recirculation system.

62. The method of claim 61, further comprising automatically switching the EC reactor the second operational mode using a controller to the first operational mode of the EC reactor.

63. The method of claim 61, wherein the first operational mode and the second operational mode of the EC reactor comprise at least one of an electrooxidation (EO) operational mode and an electroreduction (ER) operational mode.

64. A method of destroying at least one of a perfluoroalkyl and polyfluoroalkyl substance (PFAS) contained in an influent fluid stream, the method comprising:
flowing the influent fluid stream into a treatment system at an average influent rate;
destroying at least some of the PFAS in a recirculation fluid stream by flowing the recirculating fluid stream through a recirculation system having an electrochemical (EC) reactor;
removing an effluent fluid stream comprising a portion of the recirculating fluid stream from the recirculation system at an average effluent rate; and
regulating a temperature of the recirculating fluid stream with a temperature control system having a chiller.

65. The method of claim 64, wherein regulating a temperature of the recirculating fluid stream comprises running a segment of the recirculation system through a heat exchanger of the chiller.

66. The method of claim 65, further comprising pumping a coolant along a circulating flow path of the chiller.

67. A method of destroying at least one of a perfluoroalkyl and polyfluoroalkyl substance (PFAS) contained in an influent fluid stream, the method comprising:
flowing the influent fluid stream into a treatment system at an average influent rate;
flowing a recirculating fluid stream through a recirculation system having an electrochemical (EC) reactor;
operating the EC reactor to destroy at least some of the PFAS in the recirculating fluid stream;
removing an effluent fluid stream comprising a portion of the recirculating fluid stream from the recirculation system at an average effluent rate; and
automatically regulating at least one fluid property of the recirculating fluid stream.

68. The method of claim 67, wherein automatically regulating the at least one fluid property of the recirculating fluid stream comprises using at least one sensor to detect at least one of a chemical concentration, a temperature, a conductivity, a pH level, and a foam amount.

69. The method of claim 68, further comprising injecting at least one chemical into the recirculating fluid stream at least in part upon receiving a signal from the at least one sensor.

70. The method of claim 69, wherein injecting at least one chemical into the recirculating fluid stream comprises injecting at least one of a sodium hydroxide, a sulfuric acid, an antifoam chemical, and potassium hydroxide.

71. A method of destroying at least one of a perfluoroalkyl and polyfluoroalkyl substance (PFAS) contained in an influent fluid stream, the method comprising:
flowing the influent fluid stream into a treatment system at an average influent rate;
flowing a recirculating fluid stream through a recirculation system having an electrochemical (EC) reactor;
operating the EC reactor to destroy at least some of the PFAS in the recirculating fluid stream;
removing an effluent fluid stream comprising a portion of the recirculating fluid stream from the recirculation system at an average effluent rate; and
reducing an amount of foam generated by the EC reactor by dispensing a portion of the recirculating fluid stream directly downward over a central region of the EC reactor using an overhead nozzle positioned vertically over the central region of the EC reactor.

72. The method of claim 71, further comprising injecting an antifoam chemical into the recirculating fluid stream using a chemical management system.

73. The treatment system of claim 1, wherein the portion of the recirculating fluid stream dispensed by the overhead nozzle comprises recirculating fluid stream reclaimed from a bottom portion of the container of the EC reactor.
